(19) United States
(12) Patent Application Publication
(10) Pub. No.: US 2004/0085478 A1
(43) Pub. Date: May 6, 2004

(54) Radio controlled tiled video display apparatus and method

(76) Inventor: Dean VanDruff, Saratoga, CA (US)

Correspondence Address: Dean VanDruff, 14220 Pike Road, Saratoga, CA, 95070, US

(21) Appl. No.: 10/288,853

(22) Filed: Nov. 6, 2002

(51) Int. Cl. H04N 9/12; H04N 5/66

(52) U.S. Cl. 348/383; 348/385.1

(57) ABSTRACT

A radio controlled tiled video display system, where each RF display tile receives video signal from a central controller and broadcast unit rather than from electrical interconnection. Each RF display tile has a unique ID which is mapped into a control unit. The control unit broadcasts to each tile separately to create the overall image. Complex interconnect schemes of the prior art are thus replaced by complex computing in the central controller and high-speed RF broadcast. By means of the present invention, very large flat-panel displays are now possible to cost-effectively manufacture and install in the field.

### BACKGROUND OF THE INVENTION

1. Technical Field

The present invention is directed to a large flat-panel video display made up of smaller tiles which are coordinated by radio-frequency signals from a nearby broadcast controller. More specifically, the present invention is directed to an apparatus and method to organize a number of tiles to create a larger resultant image, where a controller breaks up the image and broadcasts via RF signal to each tile individually.

2. Description of Related Art

The utility of using smaller display tiles to make up a larger composite screen is well known in the art, and described in the referenced patents.

Previous innovations to lower cost through a tiled strategy have largely failed due to the resultant complexity of tile-to-tile signal electrical interconnect schemes.

What is needed for tiled displays to be viable is a means to achieve the benefit of reduced cost of smaller, mass-produced panels without the compensating cost increase and manufacturing difficulty of physically routing the signals to each panel. The solution is an ability to supply image signals to each individual tile without having to route them through other tiles, a backing network, or matrix. Then the tiles can expand to fill an entire wall or side of building if need be.

The present invention is a unique approach which makes it possible to install video tiles wherever desired. The present invention allows a wall or area to be filled with video tiles which are analogous to floor tiles, with a similar degree of difficulty/ease of installation.

This achieves the goal of being able to effectively “wallpaper” a wall or room with video tiles. Large scale displays are thus made possible by avoiding the complexity of interconnects and signal routing, instead moving this complexity into a central controller and using RF signals in open air to coordinate and control the tiles.

In short, the present invention uses EM radiation and fast processing instead of routed wires and interconnects.

Unique, novel, and somewhat counterintuitive at first glance to those skilled in the art, the present invention can be implemented now and with existing technologies. Future advances in RF device manufacturing and processing speed will make the present invention all the more attractive.

### SUMMARY OF THE INVENTION

The present invention provides an apparatus and method to control a number of smaller video tiles to make up a large resultant display. Each tile has RF reception capability to receive signals from a nearby controller, and a unique ID or serial number. The controller is programmed to know where each tile is placed, and the controller broadcasts via RF the appropriate signal to each individual tile ID.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

FIG. 1 is an exemplary drawing of a Radio Controlled Tiled Video Display system;

FIG. 2 is an exemplary drawing of the backside of an individual Radio Frequency Display Tile;

FIG. 3 is an exemplary front-side close-up drawing of the intersection of four individual Radio Frequency Display Tiles;

FIG. 4 is an exemplary drawing of the Radio Frequency Display Tiles in ID Display Mode;

FIG. 5 is a flowchart outlining an exemplary installation setup of the present invention;

FIG. 6 is a flowchart outlining an exemplary runtime operation of the present invention;

FIG. 7 is an exemplary drawing of a Radio Controlled Tiled Video Display system installed on an entire wall in a home or office.

### DETAILED DESCRIPTION OF THE PREFERRED EMBODIMENT

The present invention is a Radio Controlled Tiled Video Display (RCTVD) system. Each individual Radio Frequency Display Tile (RFDT) has a unique ID. The location of each RFDT is mapped into the Controller and Broadcast Unit (CBU). With the CBU programmed to know where each RFDT is located in the display grid, the CBU broadcasts a specific signal to each RFDT to create the overall desired image.

Each RFDT has an RF reception device with a unique ID, and is its own self-contained image display system. The CBU breaks the overall desired image into appropriate sections and broadcasts to each RFDT accordingly. While this is a complex process to initially deploy and implement, once implemented in software and silicon the cost to manufacture and replicate is relatively low compared to other approaches for large screen displays.

FIG. 1 is an exemplary drawing of a Radio Controlled Tiled Video Display (RCTVD) system. In this example, an input cable 11 provides video input to the Controller and Broadcast Unit (CBU) 12. The CBU has a map of the physical location of all of the Radio Frequency Display Tiles (RFDTs) 14, and transmits 17 to each RFDT accordingly to create the overall image 16. The RCTVD map and other setup and control functions are supplied through a computer interface cable 18, which computer interface can be of any type including a wireless connection. A power distribution strip 15 or strips for the RFDTs may also be included.

RCTVD systems can be any shape, can be noncontiguous across architectural features, and even include ceilings if desired.

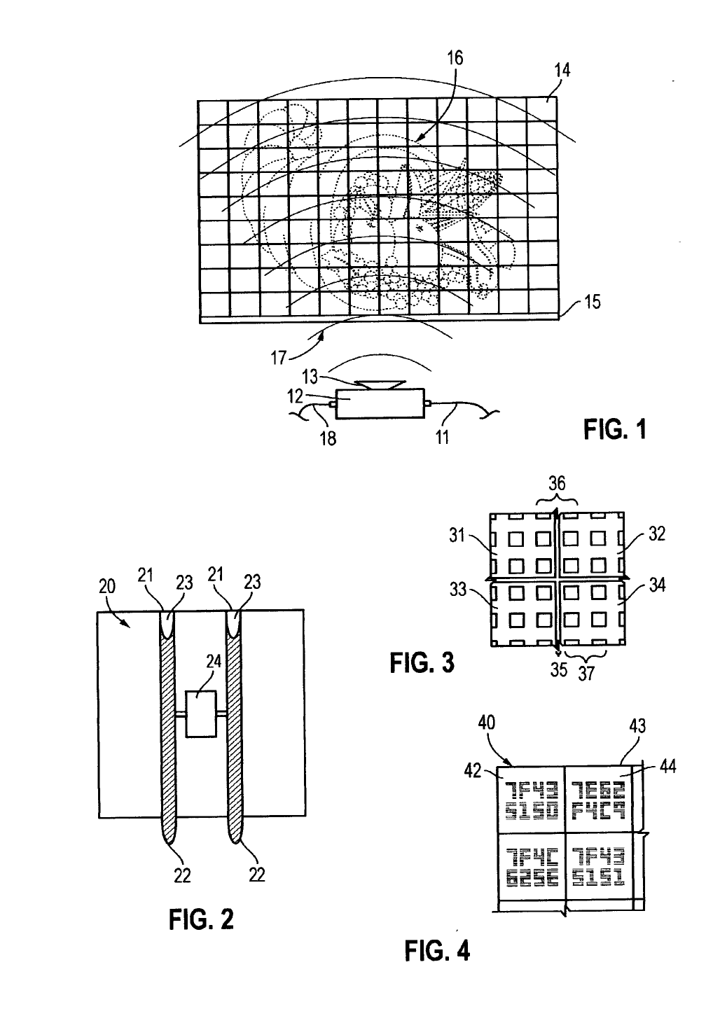

FIG. 2 is an exemplary drawing of the backside 20 of an RFDT. Power supply strips 21 run vertically from top to bottom in this exemplary embodiment, with the strips extending beyond the tile on the bottom 22. The exemplary strips have exposed metal on the side not shown 22 which slide into or otherwise make contact with the exposed side 23 of the next RFDT down. In this embodiment, the RFDT circuitry resides between the power strips 24, and may be sealed in for protection.

The backside 20 of the RFDT may be covered in whole or part with a double-stick foam adhesive (not shown) for attachment to a wall or other substrate surface. A planar, flat backing surface may also be part of an installation on walls. Such backing might integrate a variant power distribution scheme than that depicted in FIG. 2. Other means to provide power to the RFDTs, including RF broadcast, are within the scope of the present invention.

To mask the physical seams on the viewing side, a plastic covering may be installed over the RFDTs.

FIG. 3 is an exemplary front-side close-up drawing of the intersection of four 31, 32, 33, 34 individual Radio Frequency Display Tiles (RFDTs). In this embodiment, the unusable edge surface area and gap between tiles 35 fits within the spacing of the pixels 37 such that no image pixels are lost 36 from one RFDT 31 to the next 32.

An example XVGA 1024×768 resolution RCTVD system with 12 by 9 (108) RFDTs would require that each RFDT have a resolution of 85 by 85 pixels. Thus, the image can be made to appear continuous across the tiles 35.

While the seamless pixel positioning of FIG. 3 is preferred, another embodiment is to skip one or more pixels across the tile intersection gap 35. This would create perceptible grid lines, but such is the state of the art in multi-CRT-displays as well as some large format tiled LCD display systems. While not preferable, grid lines might be acceptable for low-cost large-scale RCTVD displays, as the gap between RFDTs 35 will be less than other competitive implementations.

FIG. 4 is an exemplary drawing of RFDTs in ID Display Mode when being installed. After the RFDTs are put into place 40, 43, the CBU sends a signal which instructs all of the RFDTs to display their unique ID numbers 42, 44. These are then input into the CBU to create the transmission map.

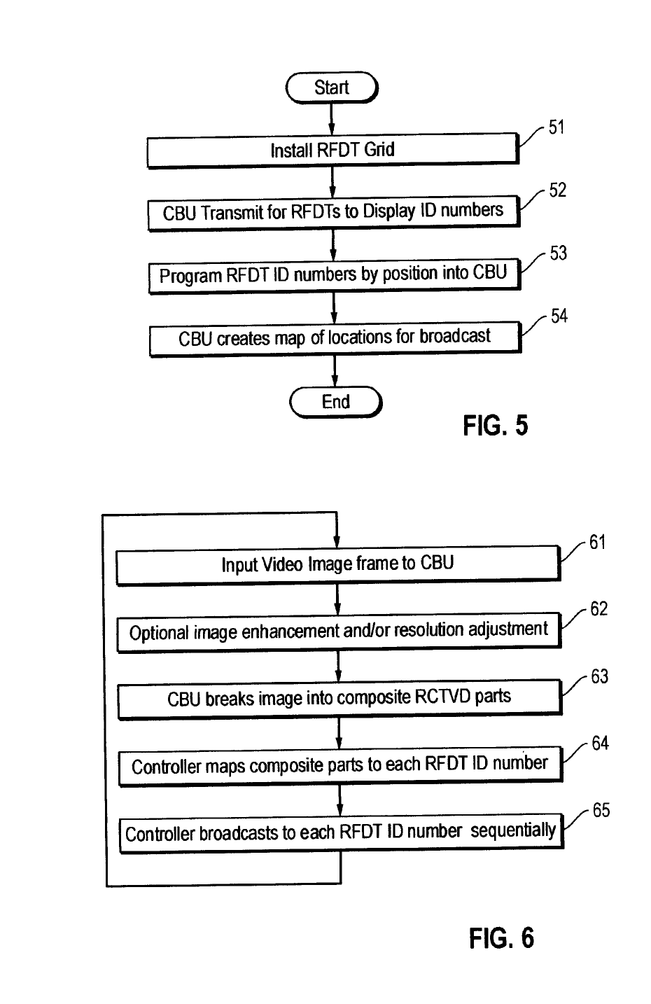

FIG. 5 is a flowchart outlining an exemplary installation setup as previously described in FIG. 4. After the RFDTs are installed 51, the CBU sends a signal for the tiles to display their unique ID numbers 52. These are then programmed into the CBU 53 through a computer interface cable or other connection to create the transmission map 54.

This example is not meant to limit the various means of detecting the positions of the RFDTs within the present invention, but rather to demonstrate one means by which an RCTVD system can be set up.

An alternative to the illustrative example given in FIGS. 4 and 5 is to insure that the RFDTs are installed with sequential ID numbers 42 for ease of CBU programming. Another alternative is to capture the ID numbers via video camera or other means to be automatically fed into the CBU.

A test pattern may then be displayed across all the RCTVD tiles to insure proper mapping and installation. Further adjustments to the brightness, color, etc. of each RFDT may be done for the purpose of uniform image appearance across the tiles. Such calibration factors may be stored in the CBU for inclusion in the broadcast signal, or alternatively in the RFDTs for post-processing upon reception. Either the CBU or the RFDTs may also change the resolution of the broadcast image or otherwise enhance or modify the image once received. Many such options will be apparent to those skilled in the art.

FIG. 6 is a flowchart outlining an exemplary runtime operation of the present invention. Video is input to the CBU and a frame is captured 61 at the RCTVD refresh rate. Any image enhancement or resolution adjustment may then be performed 62 in the CBU. The CBU breaks the image into tiled segments in accordance with the configuration of the RFDT grid 63, and associates these segments with each particular RFDT ID # 64. The CBU then broadcasts to each RFDT ID sequentially 65, and the process repeats for the next frame.

RCTVD broadcast options include all existing standards and protocols of transmission as well as any new or custom developed approaches in the future.

A limitation of the present invention if implemented with existing wireless LAN (WLAN) standards is that to achieve resolution, color depth and/or refresh rate must be reduced. In the short-term, this limitation is offset by the ability to create very large flat-panel displays at a relatively low-cost. And in the long-term, higher bit-rates via emerging wireless standards and less expensive RF devices will continually improve the price and performance of RCTVD systems.

It should be noted that regardless of refresh rate, RFDTs can be made to display a consistent image until the next image frame is sent. Thus, display image presence (flicker) is not a systemic problem. Bandwidth limitations due to low refresh rates in early RCTVD embodiments will show up mainly in strobed representation of fast-moving images.

An example RCTVD system of 12 by 9 (108) RFDT panels with an overall resolution of 640×480, 8 bit color depth, and 10 cycles-per-second refresh requires 25 Mbps of transmission bitrate, which is possible within IEEE 802.11a and HiperLAN2 WLAN protocols. A variant example of the above is 12 bit color depth at 7 cycles-persecond, which also would fit within a 25 Mbps effective bit-rate. Reducing the refresh to 2 cycles-per-second and 8 bit color places the bit-rate within the proposed BlueTooth WLAN standard. In any of these cases, with 1 ft square tiles, this would yield a wall-size 12 ft by 9 ft screen at VGA computer monitor resolution overall.

A high resolution RCTVD system of UXVGA 1600×1200 resolution at 16 bit color depth with a refresh rate of 60 cycles-per-second require 2 Gbps effective RF bit-rate. A future high-speed transmission scheme would need to be developed to implement this.

A potential benefit of the operation of RCTVD is that at slower refresh rates the entire picture is not changing all at once but being refreshed continually throughout. This “tiling” effect, however, might be distractive in some applications. To avert this, an option may be for all the RCTVD RFDTs to be programmed to wait until the CBU issues a “next” signal before going to the next frame stored in video-ram; somewhat like a slide show. Another option for fairly static images is for the CBU to only broadcast to changing RFDTs within the overall image to achieve a greater effective refresh rate when this is possible.

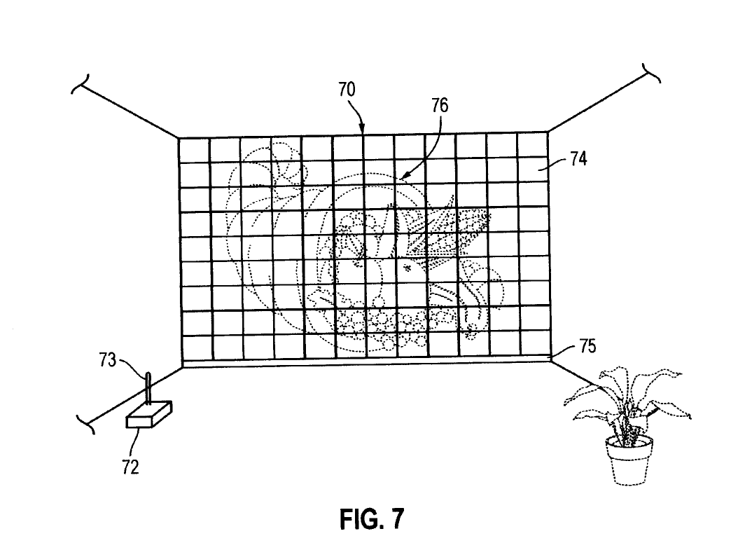

FIG. 7 is an exemplary drawing of a RCTVD system installed on an entire wall 70 in a home or office. The CBU 72 transmits 73 to the individual RFDTs 74 to create the overall image 76. The RFDTs get power from the strip 75. Depending on what image is input, an RCTVD system allows for a wall to be a living nature scene, a large-screen television, a computer monitor, a picture of a wall with a window and curtains, or simply a wallpaper pattern; to mention but a few possibilities.

RCTVD RFDTs can be implemented with all existing LCD and flat-panel technologies including emissive, reflective, or transmissive, gas discharge, as well as other technologies yet to be developed. Existing technologies include, but are not limited to, field emission, light-emitting diode, and electro-luminescent displays.

The RCTVD approach avoids complex signal interconnects between display tiles for the following benefits: 1) reduced cost to manufacture the tiles, 2) avoidance of signal connection scheme reliability issues, 3) scalability to wall or larger size areas, 4) practical ability to install tiles in the field, 5) ability to implement across a wide variety of existing and future display technologies and communications protocols.

While the present invention is described and shown in the preferred embodiments depicted, it should be apparent by those skilled in the art that other embodiments not shown would be within the spirit and scope of this invention. The description of the present invention has been presented for purposes of illustration and description, but is not limited to be exhaustive or limited to the invention in the forms disclosed. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for a tiled display system comprising:
a plurality of display tiles wherein each tile has RF reception capability and a unique ID;
a controller which is programmed with the location of each display tile, and broadcasts to each display tile ID accordingly to create the desired overall image.

2. The method of claim 1, wherein the display tiles are of any technology type.

3. The method of claim 1, wherein the RF broadcast protocol is of any type.

4. The method of claim 1, wherein the display tiles have a pixel spacing such that the gap between the tiles is within the shadow area between pixels.

5. The method of claim 1, wherein the controller interpolates or otherwise computes a higher or lower resolution than the input signal, or otherwise adjusts or enhances the image to be broadcast.

6. The method of claim 1, wherein the individual tiles can be instructed to change resolution, adjust color or brightness, or otherwise enhance the image received via broadcast.

7. The method of claim 1, wherein the controller is broadcasting to more than one planar surface in an area to create a resultant surround image.

8. The method of claim 1, wherein instead of a unique ID each display tile is designed to receive on a unique frequency or sequence of hopping frequencies to achieve the same effective RF control.

9. An apparatus for a tiled display system comprising:
a plurality of display tiles wherein each tile has RF reception capability and a unique ID;
a controller which is programmed with the location of each display tile, and broadcasts to each display tile ID accordingly to create the desired overall image.

10. The apparatus of claim 9, wherein the display tiles are of any technology type.

11. The apparatus of claim 9, wherein the RF broadcast protocol is of any type.

12. The apparatus of claim 9, wherein the display tiles have a pixel spacing such that the gap between the tiles is within the shadow area between pixels.

13. The apparatus of claim 9, wherein the display tile elements have power routed to them through electrical interconnection.

14. A computer program product for a tiled display system comprising:
a plurality of display tiles wherein each tile has RF reception capability and a unique ID;
a controller which is programmed with the location of each display tile, and broadcasts to each display tile ID accordingly to create the desired overall image.

15. The computer program product of claim 14, wherein the display tiles are of any technology type.

16. The computer program product of claim 14, wherein the RF broadcast protocol is of any type.

17. The computer program product of claim 14, wherein the controller interpolates or otherwise computes a higher or lower resolution than the input signal, or otherwise adjusts or enhances the image to be broadcast.

18. The computer program product of claim 14, wherein the individual tiles can be instructed to change resolution, adjust color or brightness, or otherwise enhance the image received via broadcast.

19. The computer program product of claim 14, wherein the individual tiles can be instructed to change resolution, adjust color or brightness, or otherwise enhance the image received via broadcast.

20. The computer program product of claim 14, wherein the individual tiles can be instructed to change resolution, adjust or enhance the broadcast image.

21. The computer program product of claim 14, wherein the controller is broadcasting to more than one planar surface in an area to create a resultant surround image.
